(19) United States
(12) Patent Application Publication
(10) Pub. No.: US 2010/0256823 A1
(43) Pub. Date: Oct. 7, 2010

(54) Mechanism for On-Demand Environmental Services Based on Network Activity

(75) Inventors: Sunil Cherukuri, Morisville, NC (US); Mohamed Khalid, Cary, NC (US)

Correspondence Address: Lewinski Law Group LLC/Cisco Systems, Inc., 4508 Exmoor Drive, Marietta, GA, 30667, US

(73) Assignee: Cisco Technology, Inc., San Jose, CA (US)

(21) Appl. No.: 12/418,570

(22) Filed: Apr. 4, 2009

(51) Int. Cl. G05D 23/00; G06F 15/16; G06F 1/26

(52) U.S. Cl. 700/277; 709/224; 700/295; 700/90

(57) ABSTRACT

In an example embodiment, a method includes determining the network activity associated with a predetermined area of a building and determining a desired environmental service for the area in response to the activity.

### TECHNICAL FIELD

The present disclosure relates generally to energy conservation, and more particularly, to network and presence aware intelligent lighting and HVAC systems.

### BACKGROUND

For both economic and environmental reasons, it is desirable to conserve energy and efficiently provide environmental services to a building. In that regard, most modern office buildings have automated lighting systems and automated heating, ventilation, and air-conditioning (HVAC) systems that may be configured to turn lighting and HVAC systems on/off at pre-determined times during the day. For example, a building's lights may be pre-programmed to turn off at 8:00 pm when most workers are gone for the day. While such systems provide some level of energy conservation, they do no account for the varying schedules of modern workers who may arrive early, leave late, be out of the office for part of the day for a meeting, be gone all day on vacation, etc.

### BRIEF DESCRIPTION OF THE DRAWINGS

FIG. 1 depicts an example embodiment of a method of the invention.

FIG. 2 depicts an example embodiment of a system of the invention.

FIG. 3 depicts an example embodiment of a green network switch of the invention.

FIG. 4 depicts an example embodiment of a method of the invention.

FIG. 5 shows an example embodiment of a system of the invention.

FIG. 6 shows an example embodiment of the system of FIG. 5 showing associated network zones of a building.

FIG. 7 shows an example embodiment of a system of FIG. 5 showing associated environmental zones of a building.

FIG. 8 shows an example embodiment of a system of FIG. 5 showing lighting subzones.

FIG. 9 depicts an example embodiment of a flow diagram of the invention.

FIGS. 10A-10R depicts an example embodiment of an operation of the invention.

FIG. 11 shows an example embodiment of a system of the invention in which hotspots are used.

### OVERVIEW

An example method of providing environmental services to a building includes determining the network activity associated with a predetermined area of a building and providing environmental services to that area in response to the network activity. For instance, an example method may entail dividing a building into designated environmental zones to which environmental services are provided; monitoring network communications activity associated with the environmental zones; and providing environmental services to the environmental zones in response to the network activity. In one example embodiment the communications ports of a network switch are associated with various environmental zones and the ports are monitored to determine the communications activity for the environmental zones. This port activity may be used to determine the desired environmental services to provide to the environmental zones. For example, in one example embodiment, a method comprises monitoring the communications activity of a network switch associated with an environmental zone; and determining a desired environmental service for the environmental zone in response to the communications activity. The method may further include sending an environmental command signal to an environmental system to provide the desired environmental service.

An example embodiment of an apparatus of the invention comprises a green network switch having communications ports adapted for association with designated environmental zones of a building; and a green controller adapted to: monitor the communications activity of the ports, determine the desired environmental services to provide to the associated environmental zones, and send a command signal to an environmental system to direct the desired environmental system to provide the desired environmental services to the zone. In an example embodiment, a green controller includes a monitoring module to monitor communications of one or more ports of a network switch, a determinator to determine a desired environmental service for an environmental zone associated with the network switch and generate an associated environmental command signal.

An example system of the invention may comprise: a green network switch capable of determining a desired environmental services for an area of a building based upon network activity; and an environmental system adapted to provide the desired environmental services. The environmental system may be adapted to receive inputs sent from the green network switch and provide the desired environmental services accordingly. For example, the environmental system may include a controller adapted to receive instructions from the green network switch and one or more environmental subsystems, such as a lighting system, a heating system, a cooling system, a ventilation system, a power system, etc., to effectuate the desired environmental services. In one example embodiment, an environmental system may include lighting and HVAC systems that provide services under the direction of the green network switch based upon network communications activity.

### DESCRIPTION OF EXAMPLE EMBODIMENTS

Example embodiments of the invention are presented herein; however, the invention may be embodied in a variety of alternative forms, as will be apparent to those skilled in the art. To facilitate understanding of the invention, various figures are included in the description. The figures are not drawn to scale and related elements may be omitted so as to emphasize novel features of the invention. Structural and functional details depicted in the figures are provided for the purpose of teaching the invention and are not intended to limit the scope of the invention. Structures of apparatus and sequences of method operations are set forth to provide a thorough understanding of the invention. However, the examples set forth herein are not intended to be limiting, and it will be apparent to those skilled in the art that the examples can be modified in the practice of the invention. In some instances block diagrams are employed to better point out novel aspects and avoid obscuring the invention.

In most office buildings today workers work in designated work areas, such as offices or cubicles, that are provided with light, power, heat, and air conditioning. To conserve energy, it is desirable to intelligently provide these environmental services. For example, it may be desirable to manipulate the environmental services provided to a work area depending upon whether a worker is present in that work area. For example, if a worker is not present then the environmental services for that work area may be curtailed.

Most workers today use communications devices to connect to and interact with a communications network. For example, an employee may use a laptop or desktop computer in the employee's work area to access and communicate over an employer's communications network. These communications devices are typically plugged into a closet or distribution switch to facilitate network communications. Generally, when a worker is present in his work area, his communications device is connected to the communications network and there is activity over a network switch used by the communications device. Likewise, if a worker is not present in his work area, then typically there is little or no activity over the network switch associated with the worker's communications device. This network communications connectivity and/or activity may be used to determine whether a user is present in a work area and what environmental services to provide to the area.

In an example embodiment of the invention, a building may be divided into a plurality of designated environmental zones that may encompass various work areas to which environmental services are to be provided. Network communications may be associated with these environmental zones and used to determine the appropriate environmental services to provide to the environmental zones. For example, the building may be divided into network zones (to which network services are provided) and environmental zones (to which environmental services are provided) and the network zones mapped to the environmental zones. Network activity detected for the various network zones can be used to indicate whether a user is present in an associated environmental zone, and whether services should be provided to that environmental zone.

In an example embodiment, the ports of a network switch may be assigned or “mapped” to particular network zones. The network zones may then be associated with different environmental zones of the building that correspond to various network zones. The activity at the ports may be monitored to determine whether a user is present in a particular environmental zone and to determine the appropriate environmental services that should be provided to the environmental zone. For example, the lights and/or HVAC services provided to a particular area, and the electrical power provided to outlets in a particular area, may be turned on/off or otherwise manipulated in response to the detected network port activity associated with that area.

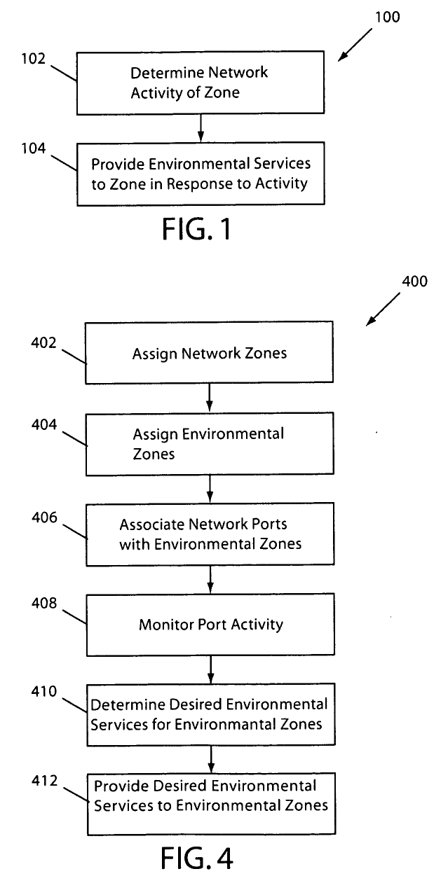

Turning now to the figures, where similar reference numbers represent similar elements throughout the views, FIG. 1 shows an example method 100 of the invention. At block 102 the network activity of a building zone is monitored and at block 104 environmental services are provided to that zone in response to the network activity.

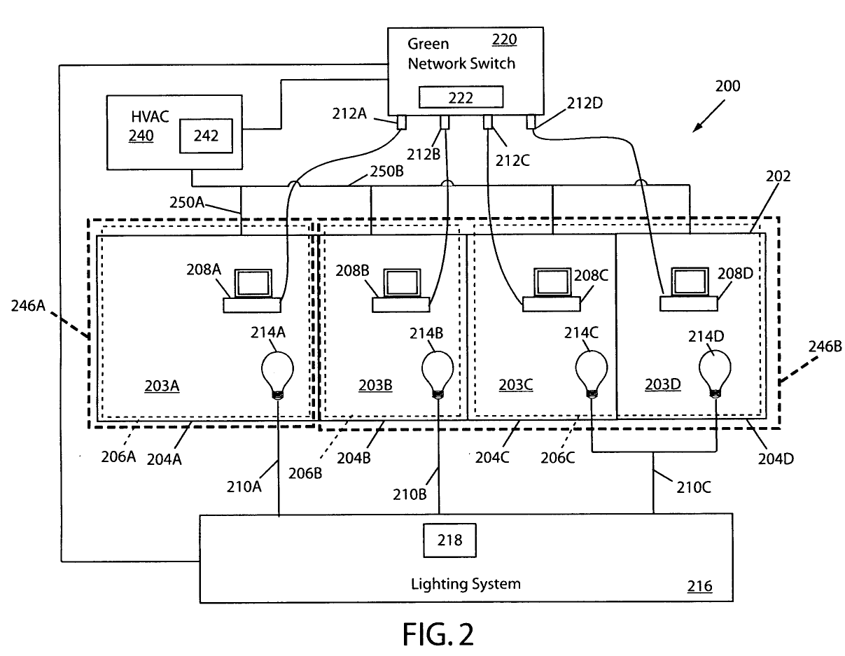

FIG. 2 shows an example embodiment of an intelligent environmental system 200. A building 202 may include a plurality of offices 203A-D, including an executive office 203A, a manager's office 203B, and two cubicles 203C, 203D. Each office 203 may include a fixed (desktop) or mobile (laptop) computer 208A-D that is coupled to a port 212A-D of a green network switch 220. The green network switch 220 may provide network services to the computers 208A-D, such as connecting the computers 208 to a network (not shown) as known in the art and provide environmental command signals to various environmental systems as described in more detail below. The areas served by the network switch ports 212A-D may define network zones 204A-D, which in this embodiment generally correspond to offices 203A-D.

The building 202 may also be divided into a plurality of environmental zones to which environmental services are provided. The environmental zones may be assigned depending upon the ability of an environmental system to provide and manipulate environmental services for those zones. In the example embodiment shown in FIG. 2, two environmental systems are provided: a lighting system 216 and an HVAC system 240 that provide lighting and HVAC services, respectively, to different areas of the building 202. The building 202 may therefore be divided into lighting environmental zones 206A-C and HVAC environmental zones 246A-B that may encompass different network zones 214A-D. It is also possible to have other environmental systems, for example electrical power outlets in different areas of a building.

The lighting system 216 may have a plurality of lighting circuits 210A-C that provide intelligent lighting services, such as the ability to turn lights on/off, and otherwise manipulate the lighting provided to particular areas of the building. For example, the lighting system 216 may include a controller 218 adapted to receive control signals from the green network switch 220, and lighting fixtures, switches, dimmers, circuits, bulbs, sockets, wiring, a power source, etc. (not shown) to effectuate the desired lighting services as instructed by the green network switch 220.

The different areas served by the lighting circuits 210A-C may define different lighting zones 206A-C. For example, one lighting circuit 210A may control lights 214A for the executive office 203A (lighting zone 206A), a second lighting circuit 210B may control the lights 214B of the manager's office 203B (lighting zone 206B), and a third lighting circuit 210C may control lights 214C and 214D for the cubicles 203C-D (lighting zone 206C).

Likewise, the HVAC system 240 may include a controller 242 adapted to receive instructions from the green network switch 220, and a thermostat, duct work, compressors, fans, furnaces, etc. (not shown) to effectuate HVAC services under the direction of the green network switch 220. The building 202 may be divided into different HVAC zones 246 (shown in bold dashed lines) for the provision of intelligent HVAC services. For example, the HVAC system 240 may include HVAC circuits or subsystems 250A-B that provide heat, ventilation, and air conditioning services to particular areas of the building, which define HVAC zones 246A-B. The HVAC system 240 may be configured to open/close ducts, turn systems on/off, adjust thermostats, or otherwise provide and manipulate the HVAC services to the particular HVAC zones 246. In the example embodiment shown in FIG. 2, a first HVAC zone 246A may correspond to the executive office 203A and a second HVAC zone 246B may include the manager's office 203B and the cubicles 203C, 203D. Note that the lighting zones 206A-C and the heating zones 246A-B do not necessarily correspond to one another and that the various environmental zones may include one or more work areas.

As also seen in FIG. 2, the green network switch 220 may include a plurality of communication ports 212A-D configured to couple with various communications devices and network components to provide networking functionality as known in the art. For example, Cisco Systems, Inc. routers/switches, such as Catalyst® 6500, Catalyst® 5500, Catalyst® 4500 series, Catalyst® 3700 series, Catalyst® 2900 series, etc. may be used. The green network switch 220 may also include a green controller 222 configured to monitor the activity at the communication ports 212A-D, determine desired environmental services for environmental zones associated with the ports in response to the activity, and send environmental command signals to environmental systems to effectuate the desired environmental services. For example, the green controller 222 may send command signals to various environmental systems in response to the network activity detected at the ports 212. In the example embodiment of FIG. 2, the network ports 212A-D serve network zones 204A-D that correspond with the offices 203A-D and included environmental zones 206A-C, 246A-B.

The environmental zones, such as the lighting zones 206A-C and the HVAC zones 246A-B, may be associated with network zones 204 of the building and the ports 212 of the green network switch 220. For example, a determination may be made as to which network zones 204 and network ports 212 correspond to which environmental zones 206, 246. The associations of the different network zones 204 and network ports 212 with the environmental zones 206, 246 may be stored at the green controller 222 and used to determine what services to provide to the different environmental zones 206, 246. For example, if the network ports associated with a particular environmental zone show that there is no network activity or connectivity for that zone then a determination may be made that there is no one present in that environmental zone and that environmental services for that zone should be reduced. In its simplest form the lighting and environmental zones would overlap.

In the example embodiment shown in FIG. 2, each network port 212A-212D is coupled to a desktop computer 208A-D located in an office 203A-D so that each office 203A-D corresponds to a network zone 204A-D, and each port 212 serves an individual office 203A-D. In this case, where the environmental zones (lighting zones 206A-C and HVAC zones 246A-B) include multiple offices, then a single environmental zone may be associated with multiple ports 212. In addition, where different types of environmental zones do not necessarily correspond with each other, a single network port may be associated with multiple environmental zones. For example, the network ports 212A-D may be associated with the lighting zones 206A-C as follows: port 212A with lighting zone 206A (the executive office 203A), network port 212B with lighting zone 206B (the manager's office 203B), and network ports 212C, 212D with lighting zone 206C (the cubicles 203C, 203D). Likewise, network port 212A may also be associated with HVAC zone 246A (the executive office 203A) and network ports 212B, 212C, 212D associated with HVAC zone 246B (the manager's office 203B and the cubicles 203C, 203D).

The activity at ports 212A-D may be monitored to determine the environmental services to provide to the various environmental zones 206, 246 and what command signals to send to the different environmental systems. As discussed in more detail below, the monitoring of network activity may be active and/or passive. For example, if there is no detected network activity at a port 212 (or ports) associated with an environmental zone, then it may be determined that no one is present at that zone, and the provision of environmental services for that zone reduced. For example, in FIG. 2, if the activity of port 212A indicates that the executive office 203A is occupied, then the lights 214A and HVAC subsystem 250A may provide lighting and HVAC services appropriate for an occupied office. If the activity at port 212A indicates that the executive office 203A is unoccupied, then the lights 214A and HVAC services 250A for that office may be turned off or otherwise manipulated as appropriate for an unoccupied office. The green controller 222 of the network switch 220 may send command signals to controllers 218, 242 of the lighting system 216 and HVAC system 240 to effectuate the desired environmental services for the environmental zones.

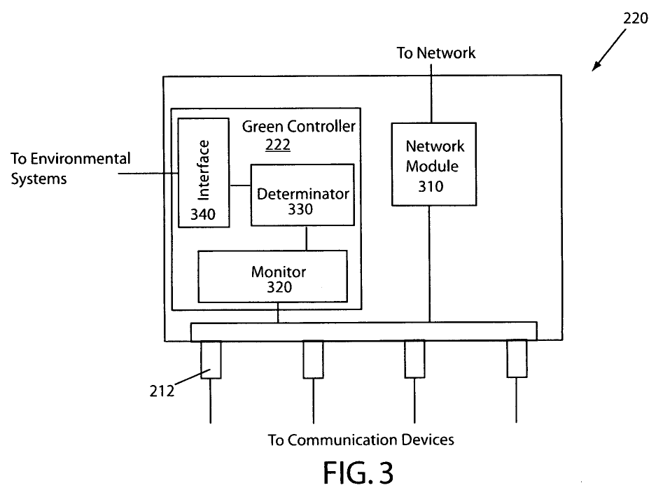

FIG. 3 shows an example embodiment of a green network switch 220. The network switch 220 may include network ports 212. The switch 220 may monitor the network ports per zone. In a passive monitoring phase, when the ports in a zone are disconnected, such as if the port goes into a down state, it indicates that there are no more users in that zone, and the network switch can communicate this information to the Lighting and HVAC systems. In an example embodiment, the green network switch may include a network module 310 that includes the necessary components to provide network functionality. For example, may include components of the Cisco Systems, Inc. Catalyst® series switches and/or other components known in the art for providing network switching services. The green network switch 220 may also include a green controller 222 that is adapted to provide intelligent environmental services functionality. The green controller 222 may include additional software that can monitor the switch-ports per zone, and communicate the status of the connectivity to the various environmental systems. The environmental systems may have a front-end software interface that can receive these signals, and take actions on controlling the corresponding lighting and HVAC zones. For example, if the network switch 220 realizes that all ports in an environmental zone are disconnected, it can send a signal to the lighting and HVAC systems that the zone is empty.

In the example embodiment of FIG. 3, the green controller 222 includes a monitoring module 320 adapted to monitor the activity of the communications ports 212 of the switch 220, a determinator module 330 adapted to determine the appropriate environmental services to provide to environmental zones in response to the port activity and generate appropriate environmental command signals, and an interface 340 adapted to send the environmental command signals to various environmental systems. The monitoring module 320, determinator 330, and interface 340 may be hardware, software, firmware, or a combination of such that is capable of performing the required steps.

As seen in FIG. 2, the lighting system 216 and HVAC system 240 may include controllers 218, 242 that are adapted to receive commands from the green controller 222 and manipulate the various environmental services accordingly. In the example embodiment of FIG. 2, the lighting 216 and HVAC systems 240 are shown separately, but could be combined into a single system with a single controller, if desired.

The monitoring module 320 may include hardware and software and be adapted to determine the activity at the network ports 212, such as whether there is connectivity at the port and the activity level of the port. For example, the monitoring module may be adapted to determine what type of traffic crosses the ports, such as Open Systems Interconnection (OSI) Layer 4 traffic (like UDP, TCP), OSI Layer 3 traffic (like IP, IPX, ICMP), OSI Layer 2 traffic (like 802.3 Ethernet, 802.11, 802.1Q, ISL, CDP, LLDP); or OSI Layer 1 traffic. The monitoring module is coupled to the determinator 330 to provide the determinator 330 with the activity data. For example, the monitor may send data signals to the determinator 330 that includes presence/absence status of network activity on the corresponding ports.

The desired environmental services to provide in response to the network activity may be determined by the determinator 330 in accordance with a predetermined scheme. For example, under one scheme the determinator 330 simply determines if there is connectivity at the network ports 212 associated with particular zones. If there is no connectivity, then the determinator 330 sends a signal through the interface 340 to the appropriate environmental system to cease services for that environmental zone. When connectivity at the port 212 is reestablished then a new command signal may be sent to the environmental system to restart service to the environmental zone. One scheme may call for shutting off environmental services immediately if there is insufficient communications activity whereas another scheme may delay action for a predetermined time period. In other cases, instead of simply turning services on/off, the level of service provided may be adjusted. For example, a thermostat for a work area in which a user is not present may be simply adjusted to a different setting rather than being turned fully off. This may prevent areas adjacent to a work area from being adversely affected by the level of environmental services provided to a particular area. Factors other than network activity could also be considered when determining the desired environmental services for a zone. For example, a scheme may take into account the time of day, the time of year, etc. For example, it may be desirable to provide a minimal level of HVAC service during some times of the year even when there is no activity for a zone, or open or close the curtains of an occupied or unoccupied office depending upon the particular time of year. As discussed in more detail below, if there is network connectivity at a port, additional monitoring may be used as part of an active monitoring system.

The determinator 330 may include a memory to store various schemes and a processor to execute such schemes and generate command signals. The determinator may be coupled to the monitoring module 320 to receive monitoring data, such as information as to the activity of the communications ports. The deteminator 330 may also be programmable with the various schemes. The associations of the network ports with the various network zones and environmental zones may be stored in memory. For example, the determinator 330 may be instructed that ports 212C and 212D are associated with the third lighting zone 206C but that HVAC zone 246B is associated with ports 212B, 212C and 212D (FIG. 2). Thus, if there is connectivity detected at port 212B but no connectivity at ports 212C and 212D then the deteminator 330 may determine to turn off the lights in the lighting zone 206C but leave on the HVAC services for the HVAC zone 246B (to provide service to office 203B).

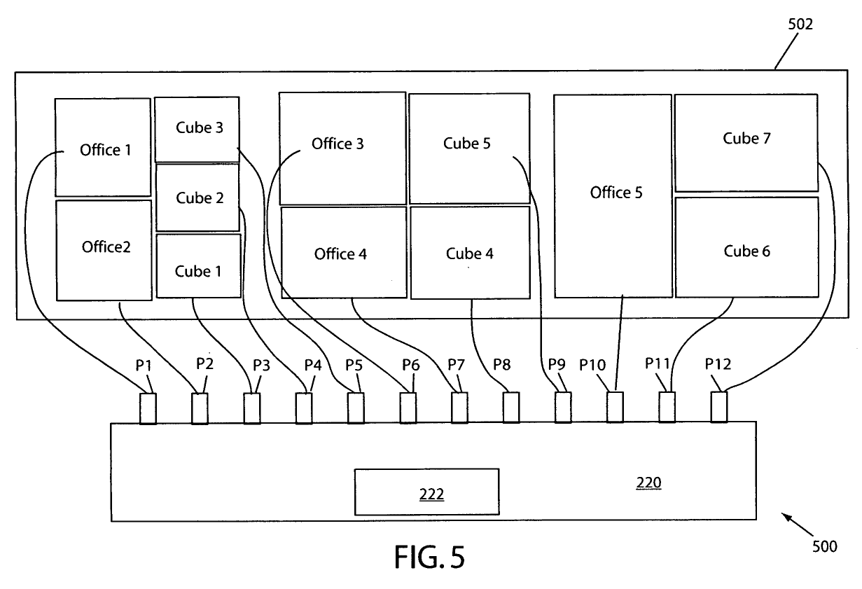

FIGS. 4 shows an example method 400 for providing intelligent environmental services. The method 400 will be discussed in conjunction with an example embodiment of an intelligent environmental system 500 shown in FIG. 5 that includes a green network switch 220 that provides intelligent environmental services to a building 502. In the example embodiment shown in FIG. 5, the building 502 includes five offices (O1-O5) and seven cubicles C1-C7, and the green network switch 220 has ports P1-P12 that serve the offices O1-O5 and cubicles C1-C7. For example, the ports P1-P12 may be coupled to computers in the offices O1-O5 and cubes C1-C7 as shown by solid lines. In this example, the ports P1-P12 are coupled to communications devices in the various work areas as follows: P1 to O1; P2 to O2; P3 to C1; P4 to C2; P5 to C3; P6 to O3; P7 to O4; P8 to C4; P9 to C5; P10 to O5; P11 to C6; and P12 to C7.

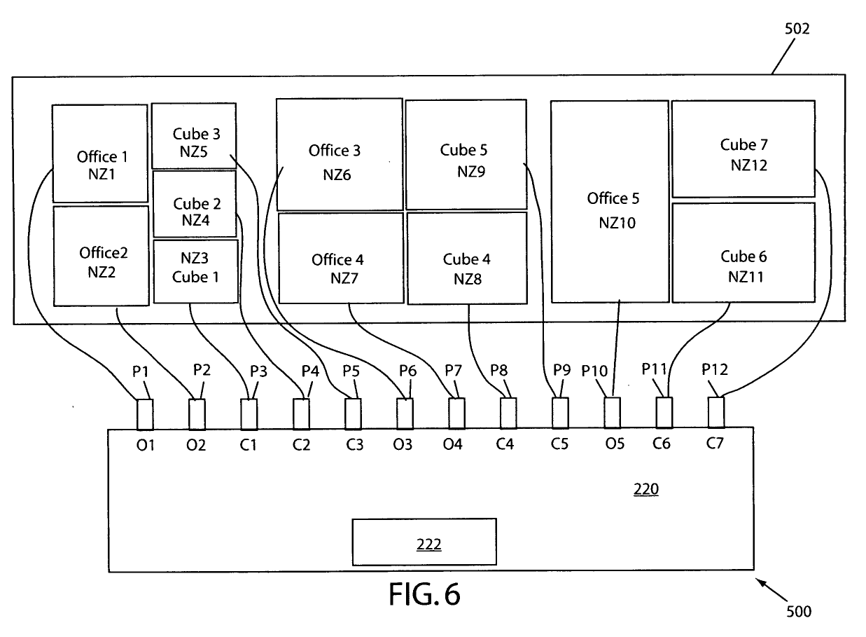

At block 402 of method 400 in FIG. 4, and as shown in FIG. 6, these work areas may be designated as network zones NZ1-NZ12 and associated with the ports P1-P12. This port-to-zone relationship may be stored at the green controller 222.

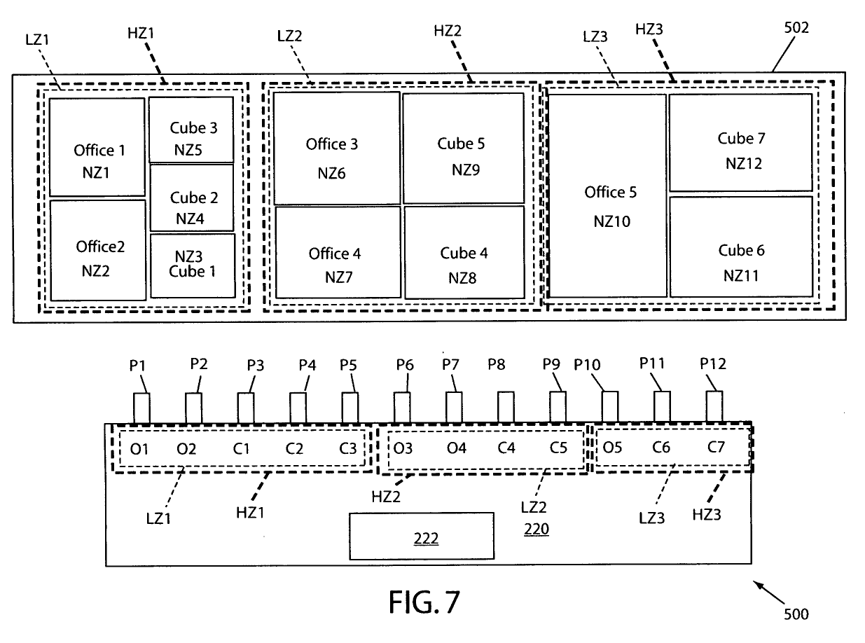

At block 404 environmental zones may be assigned and mapped to the ports P1-P12 of the green network switch 220. For example, in FIG. 7 the building 502 is divided into a plurality of different lighting zones LZ1-LZ3 and HVAC zones HZ1-HZ3 to which environmental services are provided by supporting environmental systems.

At block 406 the environmental zones LZ, HZ may be associated with the network ports. For example, ports P1-P5 (which serve offices O1, O2, C1, C2, C3 and network zones NZ1-NZ5) are mapped to the first HVAC Zone HZ1 and first lighting zone LZ1; ports P6-P9 (which serve offices O3, O4, C4, C5 and network zones NZ6-NZ9) are mapped to a second HVAC Zone HZ2 and second lighting zone LZ2; and ports P10-P12 (which serve offices O5, C6, C7 and network zones NZ10-NZ12) are mapped to a third HVAC Zone HZ3 and third lighting zone LZ3 (FIG. 7). This port-to-zone relationship may be stored at the green controller 222 and used in determining the desired environmental services for the different environmental zones LZ, HZ.

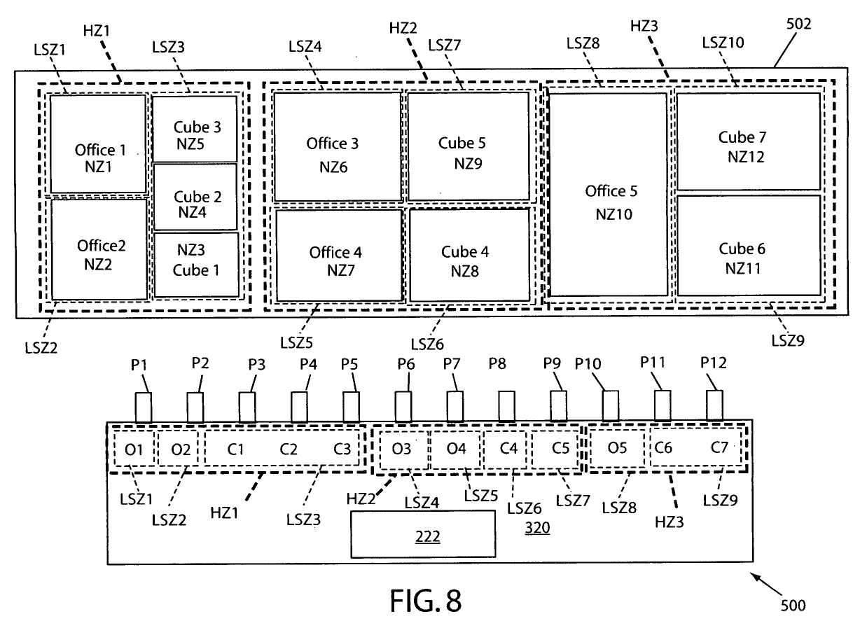

As shown in FIG. 8, the ports P1-P12 may be provided additional granular control and the building 502 further divided into lighting subzones LSZ-LSZ9 to provide additional control over the provision of lighting services. The ports P1-P12 may be mapped to the subzones LSZ1-LSZ9 and this relationship stored at the green controller 222.

At block 408, the activity at the different network ports P1-P12 may be monitored to determine the appropriate environmental services to provide to the environmental zones. At block 410 the particular services to provide to an environmental zone may be determined by the green controller 222 in response to the monitored communications activity. For example, the activity at the ports P1-P12 may be monitored by the monitoring module 320 and the resulting data sent to the determinator 330. The determinator 330 may use this data to determine if workers are present in the various environmental zones and determine the desired environmental services to provide to the environmental zones. The determinator 330 may generate and send the requisite command signals to the environmental systems to effectuate the desired services. The environmental services may be provided to the environmental zone at block 410.

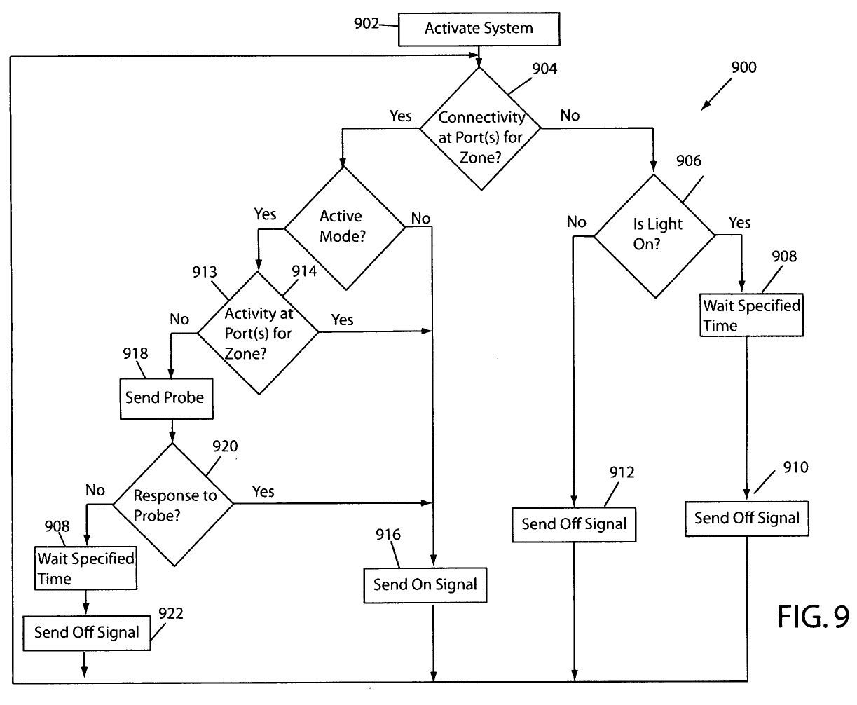

As mentioned above, the green controller 222 may determine the desired environmental services to provide to an environmental zone in accordance with a predetermined scheme. FIG. 9 shows an example embodiment of a method 900 of a system 300 that may be performed by a green controller 222. While the method is discussed in terms of manipulating the lighting of a building in response to network activity, other environmental services, such as an HVAC services, could also be similarly provided and manipulated. At block 902 the intelligent environmental system is activated. It is contemplated that a system could be activated or deactivated. For example, if the intelligent environmental system is not activated, then the various environmental systems may operate in a default mode whereby the lights of a building are switched on at 6:00 AM and off at 8:00 PM. When the system is activated, the system may use an intelligent scheme to generate command signals to the environmental systems to control provide environmental services in response to network activity.

At block 904 it is determined whether there is connectivity at a port 212 of a network switch 220 associated with an environmental zone. For example, the monitor 320 of a green controller 222 of a network switch 220 may determine whether port 212A (FIG. 2), which is associated with lighting zone 206A and HVAC zone 246A, is down. If there is no connectivity at the port 212, such as when a computer 208A associated with the port 212A is not connected to the network, then at block 906 a determination is made as to whether the light 214A of the environmental zone 206A associated with the port 212A is on or off. For example, the current mode of operation of the lighting for lighting zone 206A may be determined by keeping track of the previous environmental command signals sent by the green controller 222. If the light 214A is on, then at block 908 a specified wait time, such as five minutes, may be initiated and at block 910 an “off” command signal sent to the lighting system 216. For example, as shown in FIG. 2, a green controller 222 of the green network switch 220 may send an off signal to the controller 218 of the lighting system 216 to turn the light 214A off. The signal may be in a format readable by the environmental system to which it is sent. For example, the signal may include data relating to a desired setting of an environmental system for an associated environmental zone such as which lighting circuit 210 to manipulate. The lighting controller 218 may include hardware, software, and related structure to receive the environmental command signal and manipulate the environmental system to effectuate the command. If the light 214A is already off at block 906, then at block 912 the light remains off and may it not be necessary to send the “off” command signal. The current status of the light may be updated as “off.”

If at block 904 it is determined that there is connectivity at the port 212 then at block 913 a determination is made as to whether to enter active monitoring mode. At times it may be desirable to change between an active and passive monitoring mode. For example, after normal working hours if a communications device is still connected to the network, additional inquiry may be made as to the activity level. For example, although a communications device, such as a desktop computer in a worker's office, may be connected to a network, it may have little or no activity with the network which may indicate that a worker is not present. This may occur when a user has left the office but the communication device remains connected to the network.

If active mode is not enabled, then at block 916 an “on” environmental command signal is sent. If active mode is enabled, then at block 914 a determination is made as to whether there is sufficient activity at the port to justify environmental services. For example, a determination may be made whether there is sufficient OSI Layer 3/4 traffic to indicate that a user is present. If there is sufficient activity to indicate that a user is present, then at block 916 an “on” signal may be sent to the lighting system 216 for the associated environmental zone. For example, the signal may include an on/off command along with an identification of the associated environmental zone, such as the lighting circuit 210 associated with the command.

If there is insufficient activity at a port 212 to indicate that a user is present in the associated environmental zone, then at block 918 a probe may be sent to the communications device associated with the port 212. For example, if there is no traffic inbound or outbound on a port for a configurable amount of time (after a predetermined time, say 6:00 PM), then the switch can put the port into an active or watch mode, and a probe sent to the attached communications device. For example, a hypertext transfer protocol (http) message may be sent to the internet protocol address associated with the computer 208A asking whether the user is present. The message may be a simple pop-up message. If the message is opened, clicked, or otherwise responded to, then the response is considered an indication that the user is present. A HTTP based message probe is one example embodiment, but is not limited to this sole method of probing.

At block 920 a determination is made whether the user has responded to the probe. If there is a response, then an “on” signal may be sent by the green controller 222 to the lighting controller 218. If there is no response to the probe then at block 922 an “off” signal is sent to the lighting controller 218.

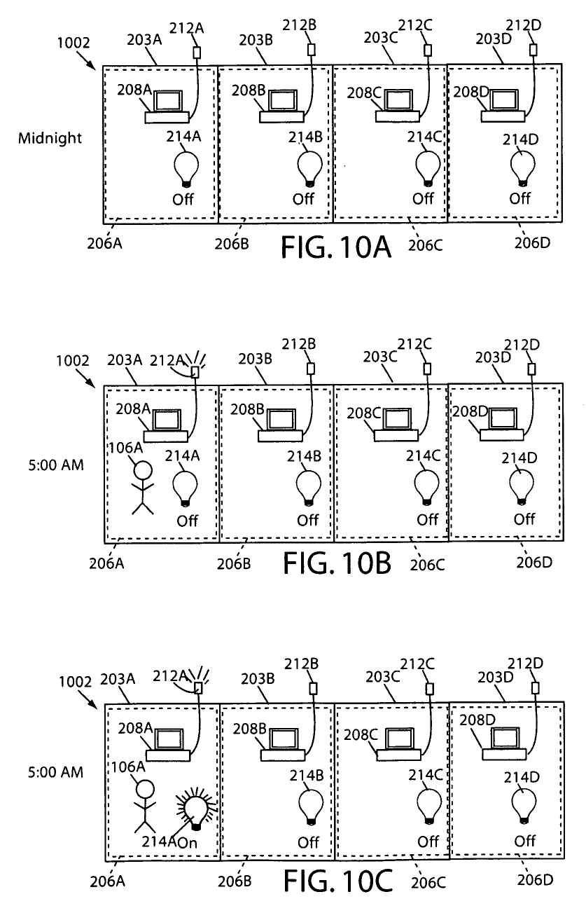

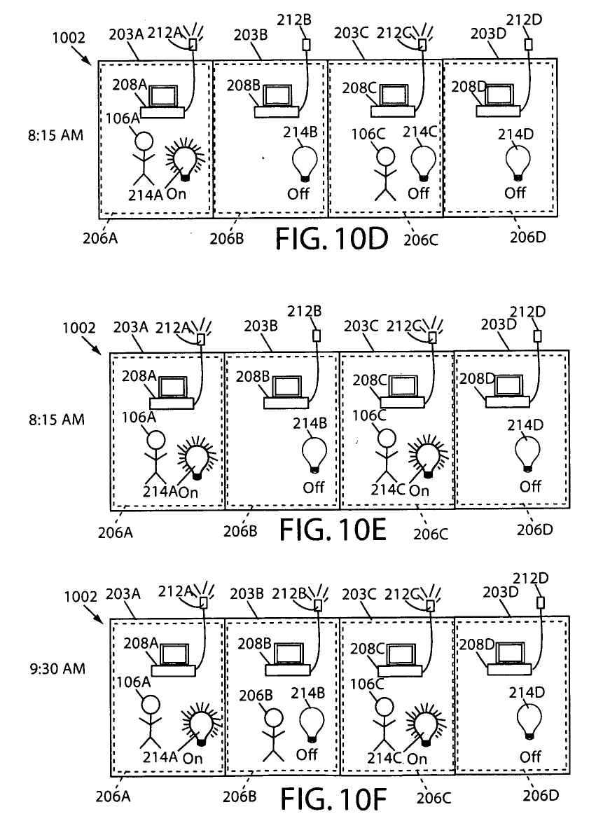

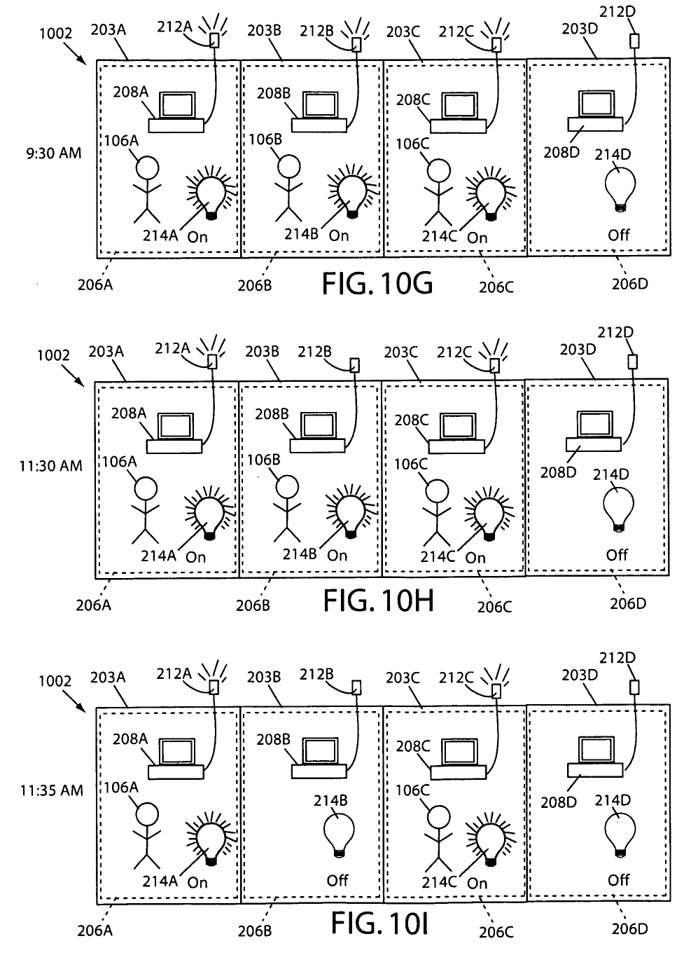

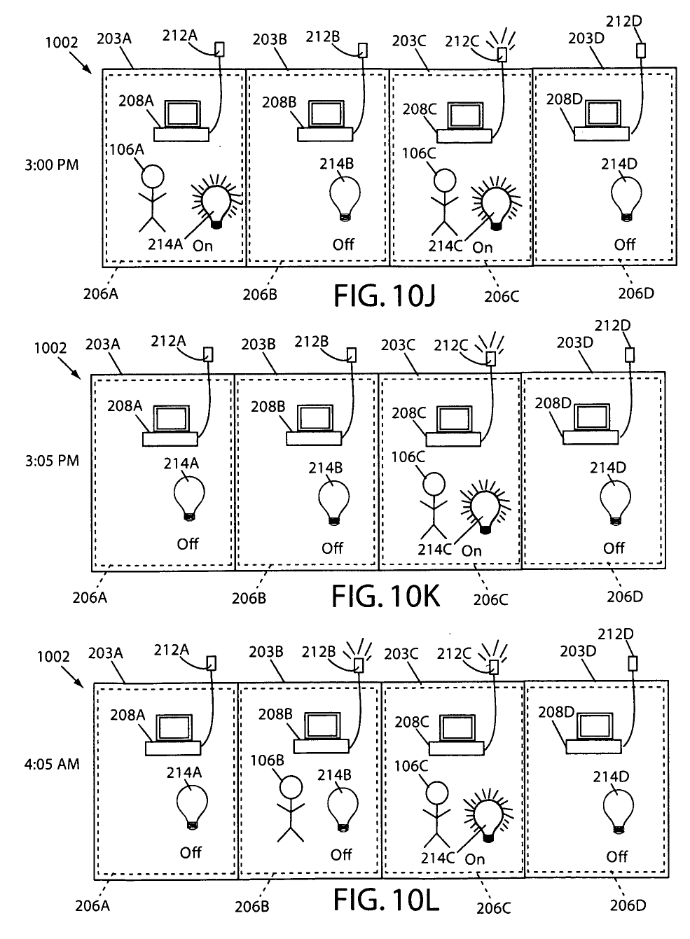

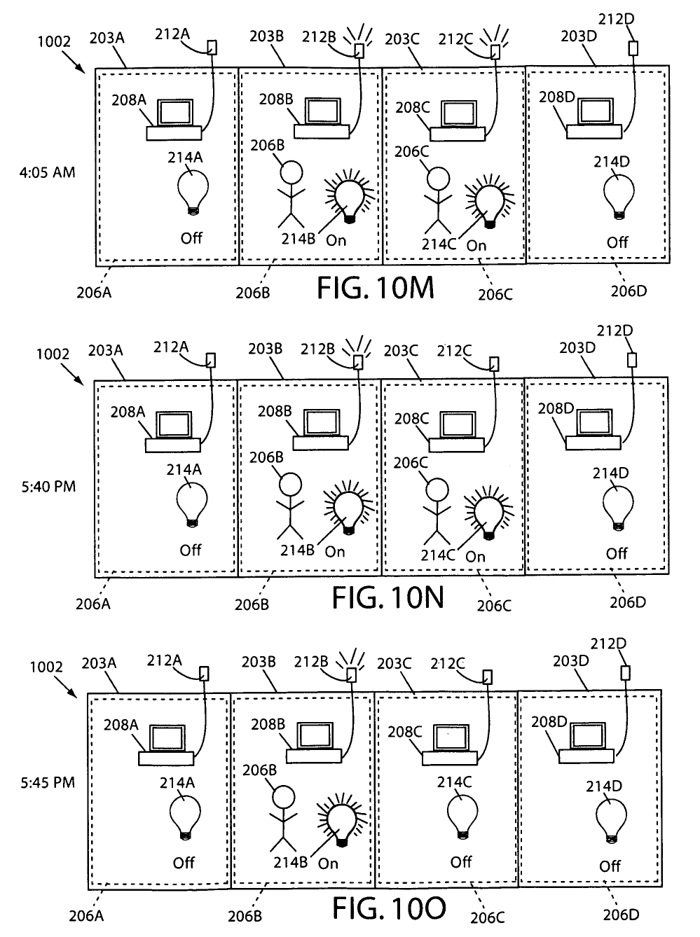

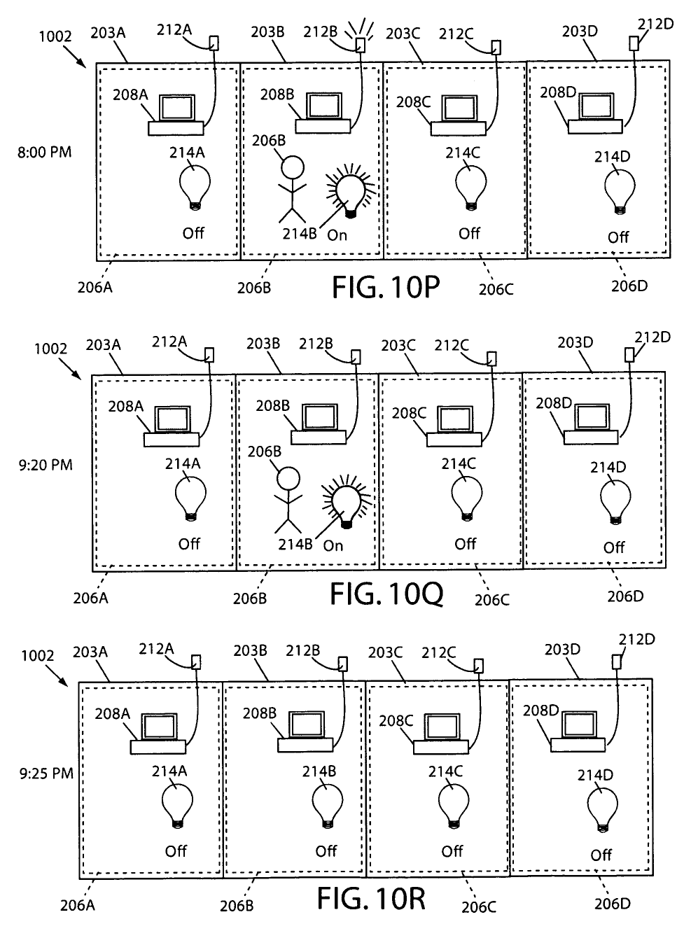

FIGS. 10A- 10R show an example of how an intelligent environmental system may work in practice. For purposes of teaching, the example shows the workings of a lighting system 200 of FIG. 2, but it will be understood that additional systems, such as the HVAC system 240, could also be employed. As seen in FIGS. 10A-10R a building 1002 is divided into four lighting zones 206A-D that provide lighting via lights 214A-D. In this example, the four lighting zones 206A-D correspond to the four offices 203A-D. Each office 203A-D has a laptop computer docking station 208A-D that is coupled to a port 212A-D of a network switch 220.

In this example embodiment, the provision of lighting services for the offices 203A-D is dependent upon the activity at the corresponding network switch ports 212A-D, i.e., the ports 212A-D have been mapped to particular offices. For example, in FIG. 10A, at midnight on a workday, there is no activity at network ports 212A-D. Accordingly, it is determined that the offices 203A-203D are unoccupied and the lights 214A-D are off. As shown in FIG. 10B, at 5:00 AM a worker 106A occupies the first office 203A and connects to the network using network port 212A. The activity at the network port 212A is detected by the network switch 220 (FIG. 2) and a command is sent to the lighting system 216 to turn on the lights 214A in the first office 203A as seen in FIG. 10C. A command may also be sent to effectuate an HVAC system (not shown) serving first office 203A. The lights 214B-D in the other offices 203B-D remain off as a lack of network activity at associated ports 212B-D indicates that those offices are unoccupied.

As shown in FIG. 10D, at 8:15 AM a worker 106C arrives at the third office 203C and connects to the network through network port 212C. This port activity is detected and the lighting system 216 turns on the lights 214C in office 203C (FIG. 10E) after being directed to do so by the green controller 222. The lights 214B, 214D remain off in offices 203B, 203D as no network activity has been detected at the ports 212B, 212D associated with those offices.

As seen in FIGS. 10F-10G, a worker 106B arrives in the second office 203B at 9:30 AM and connects to the network through network port 212B. The associated network activity is detected, and the lights 214B are turned on (FIG. 10G) upon the direction of the green controller 222.

At 11:30 AM the second worker 106B leaves for a meeting and disconnects from the network (FIG. 10H). The disconnection of the computer 208B is detected at port 212B and the lights 214B for the corresponding office 203B are turned off (FIG. 10I). The lights may be turned off immediately or after a specified time period, in this case five minutes. The delay may allow a worker to gather his belongings or perform other tasks before the lights 214B are turned off. Other specified time periods may be used. The delay in turning off the lights in the evening may be different than during the day. For example, sufficient natural light may be available during the day that turning off the lights a user may still be able to see sufficiently to gather there belongings. In addition, during normal working hours a network disconnection may be due to technical difficulties, whereas in the evening it may be more likely that a user is leaving the premises. A delay may also allow for occasional network difficulties. This delay time may be adjustable by an administrator for particular schemes.

A variety of different schemes may be employed to determine the appropriate level of environmental services. Thus, although in the example embodiment disconnection from the network is detected, other monitoring methods could be used such as determining whether a minimum level of network activity is detected or actively probing a communications device for a response. For example, if no activity is detected at a communications port 212 within a specified time interval, a determination may be made that the user is no longer present, or as discussed above, a probe may be sent to the communications device.

As seen in FIG. 10J, at 3:00 PM, the first worker 106A disconnects from network port 212A and leaves for the day. The disconnection is detected by the green controller 222, a command signal sent to the lighting system 216, and the lights 214A are turned off at 3:05 PM (FIG. 10K).

As seen in FIG. 10L, the second worker 106B returns to the office 203B and reconnects to the network using port 212B. Again the network connection is detected by the green controller 222, an on command signal sent to the lighting controller 218, and the lights 214B turned on in the second office 203B (FIG. 10M). Likewise, at 5:40 PM the third worker 106C disconnects from the network via port 212C and at 5:45 PM the lights 214C in the third office 203C are turned off (FIGS. 10N-10O).

The second worker 106B continues to work past 8:00 pm (FIG. 10P) until 9:20 PM at which time he disconnects from network port 212B (FIG. 10Q). The disconnection is detected by the green controller 222 and at 9:25 the lights 214B to the second office 203B are turned off (FIG. 10R). It should be noted that the worker that normally occupies the fourth office 203D was out sick or on vacation so that the office 203D remained unoccupied for the day. No network activity was detected at port 212D that is associated with that office 203D so the lights 214D for that office 203D were left off for the day.

In this example embodiment, the lights for office 203A were on for 10 hours, the lights for office 203B on for 7.25 hours, the lights for office 203C for 8.25 hours and lights for office 203D for zero hours for a total of 25.5 hours. In a typical automated system that turns the lights on at 6:00 AM and off at 8:00 PM without regard to whether a user is present would result in the lights for the office being on for 14 hours for a total of 56 hours.

Monitoring the communications activity of a network zone may be accomplished in a variety of ways, such as, by way of example and not limitation, monitoring of particular types of activity at the port, the frequency of usage of the port, volume of activity, etc., which may be used to determine whether a user associated with the activity is present. For example, the network activity may be whether a user is connected to a network or whether a user has activity above a predetermined level.

For teaching purposes, the example embodiments above are discussed chiefly in the context of providing lighting and HVAC services to various portions of a building. But other services could also be provided, such as, by way of example and not limitation, opening and closing curtains, providing electrical power, activating security systems, etc. For example, if an entire floor is determined to be empty based upon the network activity associated with that floor, then the refrigeration on a soda machine or water fountain may be reduced, the power to an outlet for a coffee pot turned off, an alarm system activated/deactivated, etc. In another example, when the user is determined to be not present in a particular environmental or network zone, then electrical power to all outlets in that zone may be turned off. This would benefit in turning off PC Monitors and other devices like fans, lights, stereo equipment etc that the user may have plugged in his/her office/cube.

Furthermore, in the example embodiments a single floor of a building is shown divided into various zones that are served by a single network switch. A plurality of network switches could be employed and provided throughout a building, however, and a single network switch could service multiple floors, an entire building, or multiple buildings.

The intelligent environmental system as outlined above has two modes of network activity monitoring. The passive mode addresses the scenario where users connect/disconnect laptops and other mobile communications devices to the switch ports. The active monitoring mode addresses the scenario where fixed communications devices, such as desktop computers are connected to a port (which will not be periodically connected and disconnected). In the active mode, the network switch 220 may also monitor the ports in each zone for OSI Layer 3 traffic. If there is not sufficient traffic, the switch may send a probe, which could be an http based probe that pops up a message window on the user desktop, to the IP address that is connected to that port. If a user is present at the desktop, he/she would respond “yes” to the probe. The switch now knows there is a user still connected to the port. If there is no response to the probe for a configurable time period, the switch puts the port into “unused” state. Once all the ports in the zone are not being used, the Switch can indicate to the Lighting/HVAC system to reduce the load.

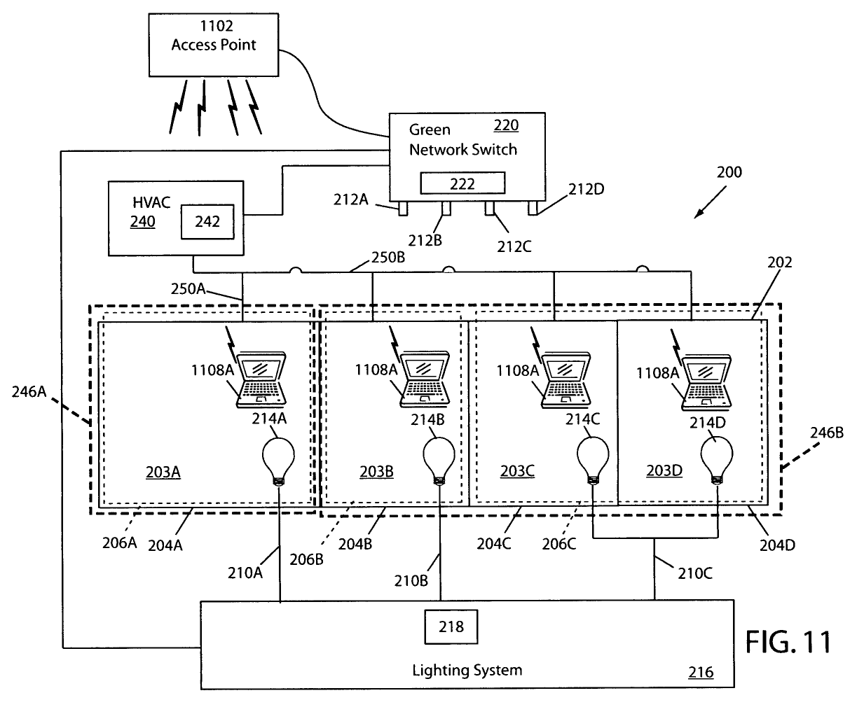

FIG. 11 shows another example embodiment of a system 1100 in the context of a wireless network. In many buildings today, users may be connected to wireless networks via links to wireless access-points, such as a WLAN, WiMAX, or WiFi access-points and/or any other suitable mobile standard. The Access-Points (AP) used in the building may be mapped to the Lighting and HVAC Zones in the building. In this example embodiment, a first access point AP1 serves the same area that corresponds to environmental zone 1, that may include lighting and HVAC subzones. The Access-Point may include additional monitoring and reporting software that can signal user connectivity to the wired network switch. The Access Point monitors how many users are connected via WiFi links to itself, and reports this status to the wired network switch. When the Access-Point-1 (AP-1) detects there are no more wireless users connected to itself, it sends a message to the network switch 220 indicating this. The switch can them mark the AP-1 as down (not being used). The switch 220 has the mapping of the Access-Point to the environmental zones it is servicing. Since the green controller 222 in the switch 220 is now aware that there is no user activity in the AP-1 and thus environmental zone-1, it may send command signals to controllers 218, 242 of the lighting system 216 and HVAC system 240 to effectuate the desired environmental services for the environmental zones. The Access-Point may also be adapted to perform active monitoring by sending probes to wireless connected users after certain times (as outlined above).

This network activity based environmental system addresses the scenarios of wired desktops, wired laptops and also wireless laptop users. Other ports on the network access switch 220 that are connected to core switches, or servers, phones, etc. can be identified as regular ports, not within the purview of the environmental systems.

Using this system, at the end of the day, when all users have left a zone; the environmental services for that zone may be turned off. If a zone still has users, then that particular zone will still have lighting and HVAC services. This avoids today's situation, where if a worker stays beyond 8:00 pm he may have to manually turn the lights on in that area because they automatically turn off at 8:00 PM. On the same note, in the morning, the lights do not have to be turned on automatically at 5:00 AM for early arriving workers. Instead, the lights can gradually be turned on as more users start arriving into their offices. This provides a system that is energy efficient and user-friendly.

The system allows lighting and HVAC services to be controlled in an on-demand fashion based on presence of user's network connectivity in the building. The decision to lower or turn off the lighting and HVAC is dynamically based on the user load in different zones of the building. The system may be implemented in Cisco System Inc.'s Catalyst® series closet/access/distribution switches for Enterprises, Connected Real Estate Solutions, etc.

What is claimed is:

1. A method, comprising:
monitoring communications activity of a network port, the network port associated with an environmental zone of a building; and
determining a desired environmental service to provide to the environmental zone in response to the communications activity.

2. The method of claim 1, further comprising:
associating the network port with the environmental zone.

3. The method of claim 1, further comprising:
generating an environmental command signal to effectuate the desired environmental service.

4. The method of claim 3, further comprising:
sending the environmental command signal to an environmental system adapted to provide the desired environmental service to the environmental zone in response to the environmental command signal.

5. The method of claim 1, further comprising:
providing the desired environmental service to the environmental zone.

6. The method of claim 5, wherein the step of providing the desired environmental service to the environmental zone comprises:
sending a command signal to an environmental system, the command signal configured to effectuate the environmental system to provide the desired environmental service to the environmental zone.

7. The method of claim 5, wherein the step of providing the desired environmental service to the environmental zone comprises:
sending a command signal to an environmental system, the command signal configured to effectuate the environmental system to provide the desired environmental service to the environmental zone; and
receiving the environmental command signal at the environmental system and providing the desired environmental service in response to the environmental command signal.

8. A green network switch, comprising:
a network module adapted to provide network services to a communications device; and
a green controller adapted to determine the network activity of an environmental zone of a building and determine a desired environmental service for the environmental zone.

9. The green network switch of claim 8, wherein the green controller is adapted to generate a command signal to effectuate the desired environmental service.

10. A green controller, comprising:
a monitoring module configured to monitor the network activity associated with an environmental zone; and
a determinator module configured to determine a desired environmental service to provide to the environmental zone in response to the network activity.

11. The apparatus of claim 10, wherein the monitoring module is adapted to monitor the communications activity of a network switch port.

12. The apparatus of claim 10, wherein the determinator is adapted to generate a command signal to effectuate an environmental system to provide the desired environmental service to the environmental zone.

13. The apparatus of claim 10, wherein the monitoring module is configured to monitor wired network activity.

14. The apparatus of claim 10, wherein the monitoring module is configured to monitor wireless network activity.

15. The apparatus of claim 10, wherein the monitoring module is adapted to actively monitor the communications activity of the network port switch.

16. The apparatus of claim 10, wherein the monitoring module is adapted to passively monitor the communications activity of the network port switch.

17. Logic encoded in one or more tangible media for execution when executed operable to:
determine an environmental service to provide to an environmental zone in response to network activity associated with the environmental zone.

18. The logic of claim 17, further operable to associate an environmental zone of a building to a port of a network switch.

19. A method, comprising:
determining the network activity associated with a predetermined area of a building; and
providing environmental services to the predetermined area in response to the network activity.

20. The method of claim 19, wherein the step of determining the network activity associated with a predetermined area of a building, comprises:
monitoring the activity of a network port of a network switch, the network port associated with the predetermined area.

21. The method of claim 19, further comprising dividing the building into a plurality of environmental zones to which environmental services are provided.

22. The method of claim 19, further comprising associating the environmental zones with the network port of a network switch.

23. An intelligent environmental system, comprising:
a green network switch adapted to provide network services and determine network activity for an environmental zone of a building and determine a desired environmental service for the environmental zone in response to the network activity; and
an environmental system coupled to the green network switch, the environmental system adapted to provide the desired environmental service to the environmental zone in response to a command form the green network switch.

24. The intelligent environmental system of claim 23, wherein the environmental system further comprises a controller adapted to receive and execute command signals from the green network switch.

25. The intelligent environmental system of claim 23, wherein the environmental system comprises a Heating Ventilation Air Conditioning (HVAC) system.

26. The intelligent environmental system of claim 23, wherein the environmental system comprises a lighting system.

27. The intelligent environmental system of claim 23, wherein the environmental system comprises a power system.
